(19) United States
(12) Patent Application Publication
(10) Pub. No.: US 2025/0212731 A1
(43) Pub. Date: Jul. 3, 2025

(54) HEMP PICKING MACHINE FOR PICKING HEMP

(71) Applicant: HYLER BV, Sint-Baafs-Vijve (BE)

(72) Inventor: Niels BAERT, Sint-Baafs-Vijve (BE)

(21) Appl. No.: 18/853,001

(22) PCT Filed: Apr. 3, 2023
(86) PCT No.: PCT/IB2023/053368

§ 371 Date: Sep. 30, 2024

(30) Foreign Application Priority Data
Apr. 1, 2022 (BE) 2022/5249
Jul. 20, 2022 (BE) 2022/5582

(51) Int. Cl. A01D 45/06; A01D 57/20; A01D 69/02

(52) U.S. Cl. CPC A01D 45/06; A01D 57/20; A01D 69/02

(57) ABSTRACT

A hemp machine for processing hemp includes a self-propelling vehicle including a vehicle chassis and a hemp picking unit mounted on the vehicle chassis for the purpose of picking the fiber plants. The hemp picking unit includes a first picking element embodied to pick the lower part of the fiber plants and a second picking element embodied to pick the upper part of the fiber plants. The second picking element has a cutting unit for cutting the fiber plants at a position between the upper and lower part of the fiber plants.

The present invention relates to a processing machine for processing fibre plants.

Numerous different machines have been developed over time for harvesting and subsequent processing of fibre plants (for instance—but not limited to—hemp, flax, sisal, jute, kenaf plants). On one hand there are picking machines with which the fibre plants in a field can be picked and with which the picked fibre plants can be placed flat on the ground surface in rows (swathes). On the other hand so-called turners have been developed with which fibre plants, once they have been placed down flat on the ground at an earlier stage, can be picked up, be turned over and can be placed back onto the ground in turned-over position. Numerous variants of these two types of processing machine are in turn known. All these variants are however configured only to turn relatively short fibre plants, such as flax. Considering the great differences in properties between the different fibre plants, including the properties such as length, but also the composition of the plants, a separate processing machine is in principle utilized for each processing step and for each fibre plant. Hemp plants are for instance characteristically between 1.4 m and 3.2 m long, flax plants are considerably shorter, characteristically for instance between 0.7 m and 1.3 m.

It has further been found that it is difficult to pick up or pick relatively long fibre plants, such as hemp plants which are long relative to flax plants, when use is made of conveyor belts sometimes applied in respective flax turning machines and flax picking machines. When the fibre plants are for instance gripped by guiding them between a running conveyor belt and a rotating pressing roller or pulley, it is sometimes not possible to get the fibre plants into the picking or turning machine in uniform and controlled manner. When the stems of fibre plants are for instance very dry, there may sometimes be little grip between the conveyor belt and the pressing roller or pulley, resulting in fibre plants remaining behind in the field. A similar phenomenon may occur at the sides of the field where a relatively small amount of fibre plants is sometimes present, when a field has been sown too thinly and/or when only a small amount of seed has remained in a field as a result of determined weather conditions. In both cases fibre plants tend to automatically become bigger, i.e. longer and with thicker stems. When picking fibre plants, and especially when the fibre plants must be pulled from the ground along with the roots and relatively great forces must therefore be exerted on the stems of the fibre plants during picking (especially when the fibre plants have become (too) big and are therefore (too) heavily rooted), in the existing picking machine the picking may result in a non-uniform supply of fibre plants (for instance in that fibre plants break or are at least damaged when picked, for instance when excessively great forces are exerted on the plants in too short a time span) and/or result in a part of the fibre plants remaining behind on the field in that stems of the fibre plants break off and the base parts remain behind in the ground surface.

It is an object of the invention to provide a fibre plant processing machine wherein fibre plants can be picked and/or picked up in efficient manner.

It is also an object of the invention to provide a fibre plant processing machine wherein a uniform supply of the picked and/or picked-up fibre plants can be ensured, preferably also in situations where there are relatively few fibre plants in some places, for instance as a result of a failed sowing pass, of weather conditions such as a storm, or of an incorrect sowing process, for instance sowing with the wrong density (wherein the density is for instance expressed in kg/ha).

At least one of these and/or other objects can be achieved in a processing machine for processing fibre plants, comprising:
a self-propelling or drawn vehicle, comprising a vehicle chassis with a number of wheels arranged thereon;
a processing unit configured to pick fibre plants or take them up from a ground surface, the processing unit comprising:
a support frame mounted or mountable on the vehicle chassis;
a transport installation mounted on the support frame and configured to receive and transport the fibre plants to the vehicle, wherein the transport installation comprises:
a number of main guide rollers mounted on the support frame;
an endless main conveyor belt guided along the main guide rollers;
a drive for driving the main conveyor belt;
a number of auxiliary guide rollers mounted on the support frame;
an endless auxiliary conveyor belt guided along the auxiliary guide rollers, wherein the auxiliary conveyor belt is configured to be driven by the displacement of the driven main conveyor belt;
wherein the main conveyor belt and auxiliary conveyor belt define a receiving area for receiving and then gripping the fibre plants for picking between the main and auxiliary conveyor belt and a mutual contact area wherein the main conveyor belt and auxiliary conveyor belt are in contact with each other;
wherein the main and auxiliary conveyor belts are positioned at the position of the receiving area in order to define a mutual distance which decreases gradually in receiving direction and transposes into the mutual contact area.

The pivotable frame is arranged on the front side of the vehicle, as seen in the transport direction, and the receiving area is also positioned on the front side of the pivotable frame. When the vehicle advances (in the transport direction), the fibre plants are thus first received in the receiving area in the receiving direction (opposite to the transport direction). The receiving of the fibre plants comprises here of having the conveyor belts bring the fibre plants together while advancing and thereby grip them until the fibre plants come to lie in the contact area in which the fibre plants are gripped firmly between the conveyor belts. The main conveyor belt and the auxiliary conveyor belt are here in contact with each other directly, or indirectly via the fibre plants situated therebetween.

By creating such a receiving area (wherein it is important that the receiving area has a sufficient size in longitudinal direction, i.e. in the direction of forward movement of the device) the fibre plants are brought together and thereby gripped between the conveyor belts more smoothly and over a longer time interval while the vehicle advances. This reduces the risk of damage to the fibre plants during picking or taking up (also referred to herein as “picking up”), of “slipping” of the fibre plants along the conveyor belts, particularly when the stems of the fibre plants are very dry, and of occasional clumping together of fibre plants when gripped, resulting in a non-uniform supply of fibre plants to the vehicle for further processing. The longer time interval in which the gripping takes place (for instance one or more tenths of a second to one second instead of immediate engagement of the fibre plants which are grasped at once between two pulleys) further makes it possible to perform a processing step, such as mowing of the fibre plants, while the fibre plants are being brought together and thereby gradually gripped. In the latter case the fibre plants are therefore not pulled from the ground along with the roots, but the roots remain behind in the field.

In determined embodiments the device comprises a number of guide elements mounted on the front outer end of the frame, as seen in the direction of travel, and configured to guide and push aside the fibre plants for picking into one or more passages, wherein the receiving area is a receiving area which is arranged between the guide elements and between a main and auxiliary conveyor belt. The receiving area is thus situated wholly on the front side of the device and is the area where the fibre plants are received first by the device. In determined embodiments the guide elements can in each case form a pointed protruding part (for instance of steel wire) so that a passage for the fibre plants in the direction of the main and auxiliary conveyor belts can be formed between each two adjacent pointed protruding parts.

In determined embodiments the auxiliary conveyor belt is configured to be driven by the displacement of the driven main conveyor belt. In these embodiments the auxiliary conveyor belt does not require separate driving, this making the construction of the machine simpler and lighter. The main conveyor belt can particularly be configured to drive the auxiliary conveyor belt in the contact area. By holding the two belts against each other in this way the auxiliary conveyor belt can run along with the main conveyor belt in simple and synchronous manner.

In determined embodiments the processing machine comprises:
a first endless main conveyor belt guided along main guide rollers;
a second endless main conveyor belt guided along main guide rollers;
a first endless auxiliary conveyor belt guided along auxiliary guide rollers and at least a first main guide roller;
a second endless auxiliary conveyor belt guided along auxiliary guide rollers and at least a second main guide roller;

wherein the first main conveyor belt and first auxiliary conveyor belt define a first receiving area for receiving and gripping first fibre plants between the main and auxiliary conveyor belt;

wherein the second main conveyor belt and second auxiliary conveyor belt define a second receiving area for receiving and gripping second fibre plants between the main and auxiliary conveyor belt;
wherein the first main and auxiliary conveyor belts are positioned in the first receiving area in order to define a mutual distance which decreases gradually in receiving direction and transposes into a first mutual contact area, and wherein the second main and auxiliary conveyor belts are positioned in the second receiving area in order to define a mutual distance which decreases gradually in receiving direction and transposes into a second mutual contact area;

wherein the processing machine further comprises:
a combining area for combining the first and second fibre plants supplied via the first and second contact area; and
a further contact area arranged between the first main conveyor belt and second main conveyor belt for the purpose of transporting the combined first and second fibre plants further between the first and second main conveyor belt.

In determined embodiments the receiving area between a main conveyor belt and an auxiliary conveyor belt is longer in the receiving direction than the greatest diameter of each of the main guide rollers and auxiliary guide rollers. This creates a minimum length which guarantees a longer gripping time than if the fibre plants were to be gripped directly between a first roller with conveyor belt and adjacent second roller lying against the conveyor belt, as is the case in known processing machines.

As already stated above, it is important for the receiving area to have a sufficient size in longitudinal direction, i.e. in the direction of travel or forward movement of the device, so that the fibre plants are pushed together and gripped sufficiently smoothly by the main and auxiliary conveyor belt at the usual travel speed. In determined embodiments the receiving area between a main conveyor belt and an auxiliary conveyor belt is to that end longer in the receiving direction than 20 cm, preferably longer than 50 cm, still more preferably longer than 80 cm. At the usual travels speeds of the vehicle (characteristically between 5 km/hour and 18 km/hour) this results in a duration for bringing together and thereby gripping a fibre plant of one or more tenths of a second to one second or more.

In determined embodiments the receiving area narrows gradually (in the receiving direction) so that a smooth gripping is advanced. This gradual narrowing can for instance be realized by having the main conveyor belt and the auxiliary conveyor belt extend obliquely relative to each other in receiving direction in the receiving area. The width of the receiving area is smaller at the start thereof than at the end (where the receiving area transposes into the contact area).

Specifically, in the receiving area the main conveyor belt and the auxiliary conveyor belt can extend in receiving direction at a mutual angle (α) between the main conveyor belt and the auxiliary conveyor belt of between 5 and 45 degrees.

This angle can be substantially constant over the whole receiving area. In other embodiments the receiving area however comprises a first receiving area part and a second, adjacent receiving area part, wherein the mutual angle (α) is greater in the first receiving area part than in the second receiving area part, for instance at least 10, preferably at least 20 degrees greater. This can for instance be realized by arranging one or more additional conveyor belt guide rollers on the support frame. In determined embodiments the processing machine comprises one or more additional main guide rollers and/or auxiliary guide rollers which are positioned at offset positions along respectively the main conveyor belt and the auxiliary conveyor belt. The main guide rollers and/or auxiliary guide rollers can here determine the start and end of each receiving area, particularly of each receiving area part. “Offset positions” is understood to mean that no rollers are positioned adjacently of each other in a direction perpendicularly of the transport direction. If a fibre plant for instance advances between the main and auxiliary conveyor belt and a guide roller (irrespective of whether this is a main guide roller or an auxiliary guide roller) is situated at a determined position on one side (i.e. the right-hand side or the left-hand side, in top view), no guide roller is provided at this position on the other, opposite side of the (main/auxiliary) conveyor belt.

The use of additional guide rollers further makes it possible to engage the fibre plants in an even more progressive manner (so gradually more firmly/with increasing clamping force). It is for instance the case that the fibre plants are gripped slightly more progressively and slightly less aggressively at the end of the receiving area because narrowing is already taking place due to the presence of the additional guide rollers.

Further provided in determined embodiments is a tensioning element on which one or more of the main guide rollers and auxiliary guide rollers are arranged. The tensioning element is configured here to be mounted on the pivotable support frame at adjustable positions, preferably continuously adjustable positions. The main conveyor belt and the auxiliary conveyor belt can hereby be tensioned together in simple manner.

In determined embodiments the auxiliary guide rollers and/or main guide rollers are manufactured from steel and/or are at least provided with a steel running surface. This has been made possible by the fact that the fibre plants are now always gripped and transported between two conveyor belts (i.e. between a main conveyor belt and an auxiliary conveyor belt). It is therefore no longer necessary to make the running surfaces of softer material (such as rubber) to protect the fibre plants (which was often necessary, especially in the known flax pickers, to develop sufficient picking force). These (running surfaces of the) rollers manufactured from steel are robust and particularly wear-resistant.

In determined embodiments the main conveyor belt has a height which is greater than the height of the auxiliary conveyor belt, for instance at least twice as high. The height of a main conveyor belt is characteristically about 100 mm, 130 mm or (preferably) 140 mm, with an auxiliary conveyor belt having a height of a maximum of respectively 70 mm, 65 mm or 50 mm.

In determined embodiments the mutual lateral distance (more particularly the distance in a direction perpendicularly of the transport direction) between the main conveyor belt and the auxiliary conveyor belt in a direction transversely of the receiving direction amounts at the free outer end of the receiving area to at least 20 cm so that a sufficiently wide strip of fibre plants finds its way into the receiving area in each case.

In determined embodiments the processing machine comprises a cutting unit which is mounted on the pivotable support frame and is configured to cut through the fibre plants when they are situated in the receiving area between the main conveyor belt and auxiliary conveyor belt. The cutting unit is positioned on the pivotable support frame so as to cut (i.e. mow) the fibre plants just above their roots.

Further advantages, features and details of the invention will be elucidated with reference to the following description of some embodiments thereof. Reference is made in the description to the accompanying figures, in which:

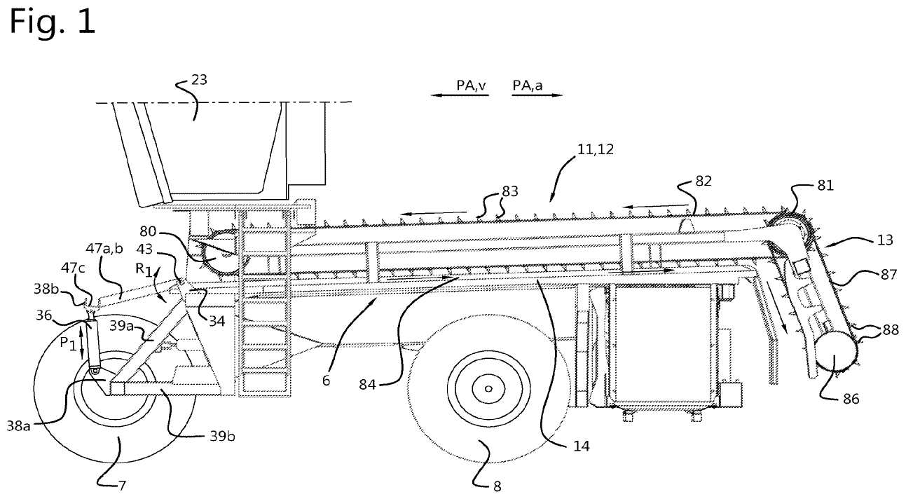

FIG. 1 is a partially cut-away side view of an embodiment of a vehicle according to the invention;

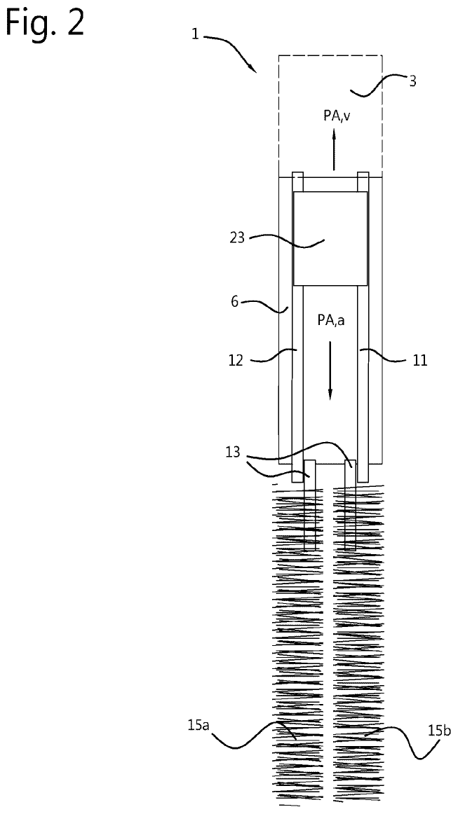

FIG. 2 is a schematic top view of the vehicle of FIG. 1, provided on the front side with a processing unit;

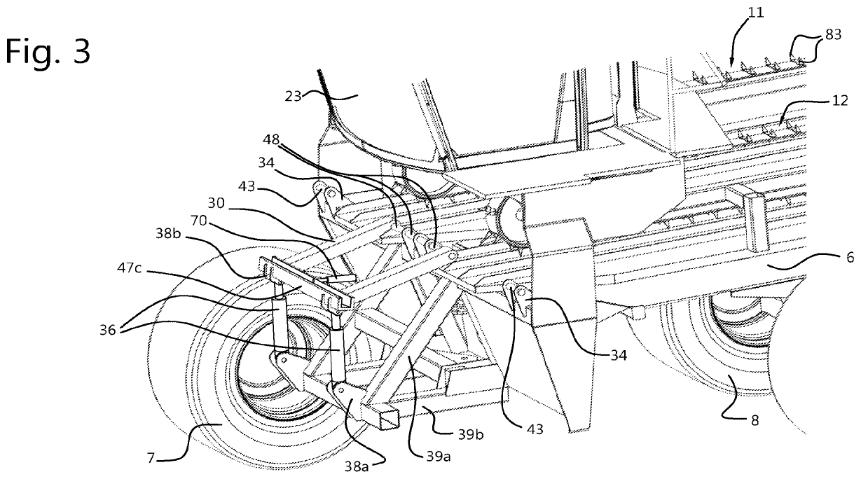

FIG. 3 is a partially cut-away perspective side view of the embodiment of the vehicle according to FIGS. 1 and 2;

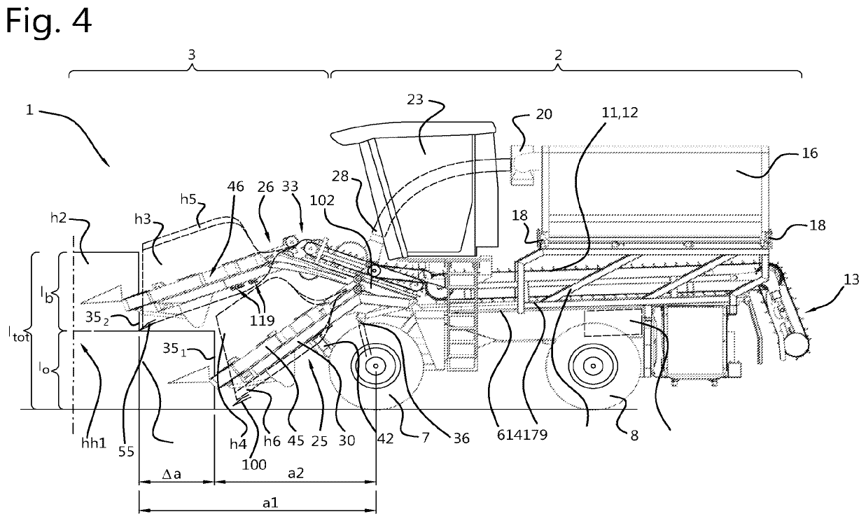

FIG. 4 is a side view of a hemp machine according to an embodiment of the invention, wherein a processing unit is mounted on the vehicle and is suitable for processing of long fibre plants;

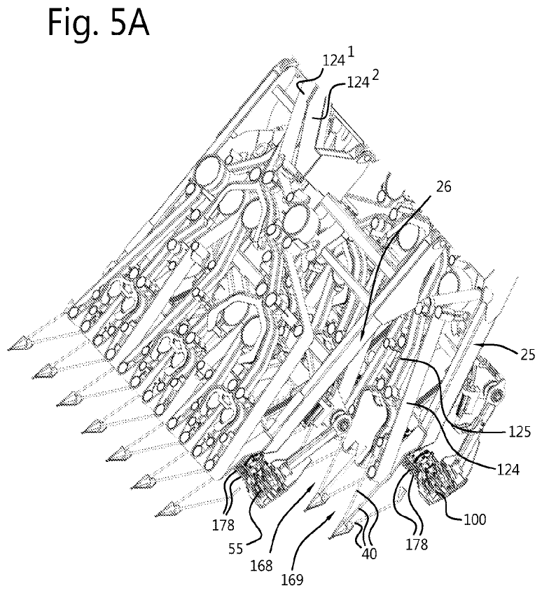

FIG. 5A is a perspective side view of a part of the processing unit according to an embodiment of the invention;

FIG. 5B is a side view of a cutting unit as part of the processing unit of FIG. 5A;

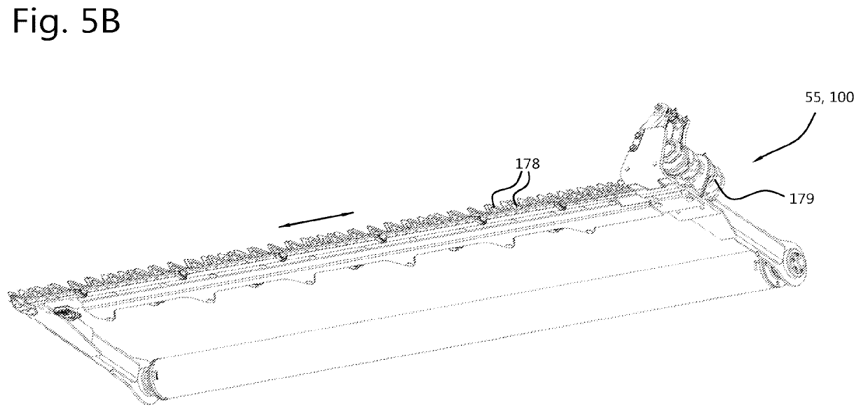

FIG. 6 is a top view of the lower picking element of the processing unit of FIGS. 5A and 5B; and

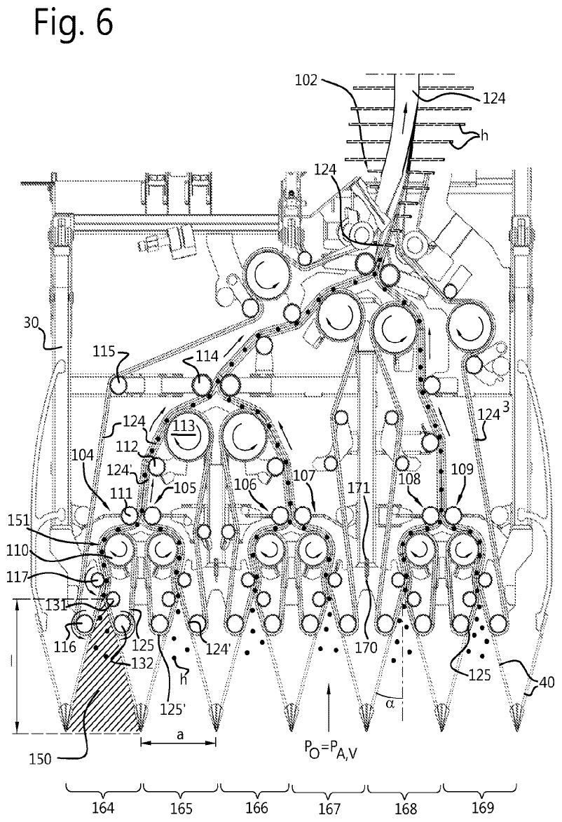

FIG. 7 is an enlarged top view of the lower and/or upper picking element of the processing unit of FIGS. 5A, 5B and 6.

Flax is a fibre crop which is cultivated for making linen, among other things. The flax plant is usually between 80 and 120 cm long, and is harvested using a drawn or self-propelling flax picking machine. For this purpose the flax picking machine has on the front side a picking unit embodied specifically to pull the flax plants from the ground. The harvested flax plants are then processed by the flax picking machine by displacing them to the rear side of the flax picking machine and placing the flax plants on the ground surface during travel. The flax plants are placed flat on the ground in long rows, also referred to as “swathes”, wherein the stems of the harvested flax plants extend substantially transversely of the longitudinal direction of the swathes. This placing back of the flax flat onto the ground surface so that said swathes are created is also referred to as “depositing” or “picking up”. When the flax plants are placed in rows or swathes, an intermediate space is left between adjacent rows. These spaces are provided in order to prevent the swathes from becoming tangled in each other.

The harvested flax plants which were placed flat on the ground in swathes are then retted under the influence of a combination of moisture and heat in the air (for instance dew, rain, sunlight) and humidity coming from the ground. The retting of the flax by leaving the flax plants on the ground (i.e. a field or retting field) for some time is referred to in the field of processing flax as field retting or dew retting. In order to obtain a uniform retting and to prevent rotting of the flax, the flax placed flat on the ground in rows must be flipped over regularly. This flipping over of the flax placed flat on the ground is also referred to as “turning”. The turning of the flax is performed using a drawn or self-propelling flax turner.

Hemp is likewise a fibre crop which is cultivated for making textile fabrics or rope, among other things. The hemp plant is a lot longer than the flax plant. The hemp plant is characteristically between 140 cm and 240 cm in length (although in the case of less successful sowing where the hemp plant has more space to grow, a length can be much greater, for instance 3.2 m or more). The hemp is usually cut at the base of the hemp plant and then processed further.

This would therefore already necessitate at least four different machines to enable optimal processing of both hemp and flax. This results in high purchase, use and maintenance costs. In embodiments of the present invention a processing machine is provided which is suitable in principle for harvesting/picking and/or turning relatively long fibre plants such as jute, sisal, hemp or kenaf and relatively short fibre plants such as flax.

FIG. 1 shows a self-propelling vehicle 2 of a processing machine 1 according to a determined embodiment of the invention. Self-propelling vehicle 2 comprises a vehicle chassis 6 on which four wheels, i.e. two front wheels 7 and two rear wheels 8, are arranged in known manner. In FIG. 1 a part of the front left side of the vehicle has been cut away (i.e. the front left wheel and the relevant part of the wheel suspension) in order to obtain a better view of the construction of the vehicle on the front side. The vehicle is self-propelling, which means that it is provided with its own drive motor whereby a number of the wheels, for instance the two rear wheels, or all the wheels can be driven. The vehicle is steered from a driver's cab 23 on the front side of the vehicle. Chassis 6 comprises two parallel conveyors 11, 12 formed by a loading floor or platform 14 (provided with steel guides or the like) and two endless conveyor belts provided thereabove. It is noted here that in operative state the conveyor belts in each case form an endless belt. The conveyor belts can for instance be constructed from a long belt, the outer ends of which are attached to each other (and optionally locked with a small lock). After or before use said outer ends of such a conveyor belt can of course be detached, for instance to enable the conveyor belt to be easily removed from the vehicle or arranged on the vehicle. At least one of the endless conveyor belts can here be adjusted in lateral direction so that the intermediate distance between the two conveyor belts can be adjusted, this in order to realize a suitable intermediate distance for shorter or longer swathes.

Referring to the top view of FIG. 2, the two conveyors 11, 12 are arranged along both longitudinal edges of vehicle 2 so that a quantity of fibre plants can be transported in axial rearward direction (P_{A,a}) with each of these. In the shown embodiment each of the conveyors 11, 12 comprises an endless conveyor belt 82 which runs on a front roller 80 and a rear roller 81. At least one of the rollers 80, 81 is driven via a drive (not shown). In a determined embodiment the drive comprises a hydraulic motor arranged in the rear (triple) pulley or roller 81. Each of the respective part-rollers of the multiple (triple) pulley is driven separately yet synchronously to each other, preferably according to a determined ratio as desired. So-called carriers 83 are provided on the outer side of conveyor belt 82. The shape, dimensions and position of these carriers may differ from those shown in the drawings. The carriers 83 can displace the fibre plants lying on platform 14, at least on guide rails 84 of the platform (FIG. 1), to the rear side of chassis 6 in said axial rearward direction (P_{A,a}). The fibre plants are thus enclosed here between conveyor belt 82 and guide rails 84.

On the rear side of vehicle 2 a delivering unit 13 is arranged for each conveyor 11, 12. In the shown embodiment the delivering unit 13 comprises an endless belt conveyor 87. The endless belt of each of the endless belt conveyors 87 is trained around a roller 86 and around said roller 81 (a belt conveyor 87 therefore sharing this with a conveyor 11 or 12). Driving of delivering unit 13 takes place via the first roller 81. This extends obliquely rearward to some extent and is configured to displace the fibre plants coming from respective conveyor 11, 12 downward in dosed and controlled manner so that the fibre plants can be placed on the ground on the rear side of the vehicle. As shown in FIG. 2, when the vehicle moves in an axial forward direction (P_{A,V}), the fibre plants (v) picked or picked up on the front side of the vehicle will be displaced to the rear side of vehicle 2 and will each be placed down on the ground (o) in a separate row 15a, 15b via delivering units 13. In determined applications the rows 15a, 15b of fibre plants are composed of the same parts of the fibre plant, for instance in the case of the relatively short flax plants. In other embodiments the one row is however composed of the lower portions of the harvested fibre plants, while the other row consists of the upper portions of the harvested fibre plants. This is for instance the case when hemp plants are harvested. In both cases the fibre plants are placed flat on the ground, parallel to each other as far as possible, after which said retting can commence.

Vehicle 2 is provided with a processing unit 3 on its front side in order to be able to pick the fibre plants or to be able to pick fibre plants already placed flat on the ground at an earlier stage back up again (see FIG. 4). A picking unit is arranged on the front side in the case that the fibre plants are being picked, while a processing unit 3 will be a pick-up/take-up unit in cases where fibre plants which have already been picked and placed on the ground previously are being picked up. A different picking unit will further be mounted on the vehicle depending on the length of the crop to be picked.

Referring to FIGS. 1 and 3 in particular, the chassis comprises on the front side of chassis 6 of vehicle 2 a number of support chassis parts 39a, 39b. The support chassis parts 39b extend in line with the rest of chassis 6 of vehicle 2, while the support parts 39a mounted on support parts 30b and the rest of chassis 6 are disposed obliquely. Chassis 6 is further provided with a number of hinges 48 on which two parallel longitudinal lifting arms 47a, 47b are arranged. Both longitudinal lifting arms 47a, 47b are connected at their outer end to a transverse lifting arm 47c. The support chassis parts 39a, 39b, longitudinal lifting arms 47a, 47b and transverse lifting arm 47c together form a strong and stable support structure for mounting a number of actuators whereby a processing unit 3 coupled to the chassis 6 of vehicle 2 can be pivoted upward and downward. Together with these actuators the support structure forms the above stated lifting unit.

The pivoting of processing unit 3 is brought about by a number of actuators, for instance electric motors or, preferably, lifting cylinders 36, of the lifting unit. In FIGS. 1 and 3 the actuators are formed by two lifting cylinders 36. In the shown embodiment two lifting cylinders positioned laterally adjacently of each other are provided. In other embodiments use is however only made of a single lifting cylinder, or three or more lifting cylinders are applied. The lifting cylinders are mounted pivotally on the support chassis parts 39a, 39b via hinges 38 and on transverse lifting arm 47c via a mounting support 38b. A further description of the construction of the lifting unit and of the operation thereof will follow below.

Referring to FIG. 3, chassis 6 is provided on either side of the support chassis parts 39a, 39b with first mounting means 34 for mounting a processing unit 3 thereon in pivotable and releasable manner. The first mounting means 34 can be embodied in numerous ways. In determined embodiments the mounting means comprise a number of flanges in which respective pivot shafts 43 can be rotatably mounted. In other embodiments use is made of a U-piece which can pivot.

Each of the different processing units 3 comprises one or more frame parts of a support frame 102, wherein the frame parts can be mounted in pivotable and releasable manner on said first mounting means 34. In the embodiment shown in FIG. 4 the processing unit 3 comprises a first, lower fibre plant processing element 25 and a second, upper fibre plant processing element 26 placed thereabove. The lower fibre plant processing element comprises a frame part 30 which can be mounted pivotally and in easily releasable manner on first mounting means 34 of the vehicle using second mounting means 32. The upper fibre plant processing element 26 comprises a frame part 33 which also takes a pivotable (yet not necessarily easily releasable) form, albeit that in the shown embodiment frame part 33 of the upper fibre plant processing element 26 is mounted on the frame part 30 of the lower fibre plant processing element 25 instead of directly on chassis 6 of the vehicle. In other embodiments (not shown) it is however precisely the upper fibre plant processing element that is mounted on chassis 6 of vehicle 2, and the lower fibre plant processing element on the upper fibre plant processing element. In still further embodiments (not shown) the two fibre plant processing elements are mounted pivotally and releasably on vehicle 2.

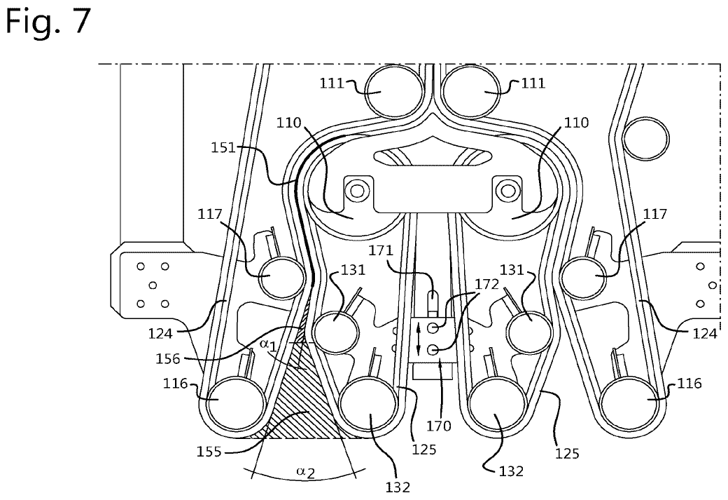

For mounting on the chassis 6 of vehicle 2, more particularly on the first mounting means 34 thereof, such as the flanges 34 positioned on or close to the sides of vehicle 2 and having the pivot shafts 43 mounted therein, the processing unit 3, in the shown embodiment the lower fibre plant processing element 25, is provided with second mounting means 32. The second mounting means 32 are embodied for easy mounting on first mounting means 34. The first and second mounting means 34, 32 together form a mounting hinge between processing unit 3 and vehicle 2, such that processing unit 3 can be pivoted in upward and downward direction around the lying pivot shafts 43 (pivoting direction R₁, FIG. 9).

To make processing unit 3 pivot relative to vehicle 2 the above-described lifting unit is utilized. As described above, the lifting cylinders 36 are arranged rotatably on the flanges 38a of chassis 6 at one outer end. On their opposite sides the lifting cylinders 36 are coupled via mounting supports 38b to the transverse lifting arm 47c. Transverse lifting arm 47c of the lifting unit has a substantially U-shaped cross-section, which is clearly visible particularly in FIGS. 1 and 3. The U-shape forms a receiving space for a part of the frame part 30 of the lower fibre plant processing element 25. In other words, the processing unit 3 can be connected to the lifting unit in simple manner by placing frame part 30 of the lower fibre plant processing element 25 into the transverse lifting arm 47c of the lifting unit from above or, conversely, by simply pressing transverse lifting arm 47c against frame part 30 from below. Finally, the whole is locked by a locking mechanism 70 (FIG. 3), for instance in the form of a remotely controllable extending cylinder which in extended state ensures that processing unit 3 remains locked to the lifting unit. The lifting unit is then ready to lift processing unit 3.

As shown with arrows (P₁) in the figures, the length of lifting cylinders 36 is controllable. It will be apparent that when the length of lifting cylinders 36 is increased, frame part 30 will pivot upward, while frame part 30 will pivot downward if the length of lifting cylinders 36 is reduced. In this way the height of the free end of the processing unit can be varied, for instance in order to adjust the position in which the processing unit grips the plants and pulls them from the ground during travel of the vehicle.

The mounting means of each of the different processing units 3 are essentially identical. This means that the different processing units can not only be easily mounted on and detached from the vehicle, but that this can also take place in a uniform manner. It is noted here that when processing units 3 are exchanged, only the mounting means of processing unit 3 (i.e. the second mounting means when the processing unit is a picking unit for long fibre plants, third mounting means when the processing unit is a picking unit for short fibre plants and fourth mounting means when the processing unit is a turning unit for turning long or short fibre plants) need in fact be released from the first mounting means of the vehicle, after which processing unit 3, particularly the frame part 30 thereof, can be removed from the upper side of cylinder 36. By now simply pacing another processing unit 3 on the lifting unit of vehicle 2 and mounting the associated mounting means on the first mounting means of the vehicle, the user can easily make processing machine 1 suitable for the specific desired process, such as picking of short fibre plants, picking of long fibre plants or taking up and turning fibre plants.

As described above, FIGS. 4-6 show an embodiment of a processing machine 1 according to the invention, wherein the processing machine is provided with an improved inlet for receiving and gripping hemp plants and transporting them to the vehicle.

Referring to FIG. 4, processing unit 3 comprises a lower fibre plant processing element 25 and an upper fibre plant processing element 26 arranged thereabove. The lower picking element 25 is mounted on the first mounting means of the vehicle in the above stated manner, this such that the first fibre plant processing element 25 can be pivoted in upward and downward directions by controlling said lifting cylinders 36. The upper fibre plant processing element 26 is pivotally arranged via pivot shafts 43 on the lower fibre plant processing element 25 so that the upper fibre plant processing element 26 can be pivoted (pivoting directions relative to the first fibre plant processing element 25 (and relative to vehicle 2 and the ground surface). The pivoting movement of the upper fibre plant processing element 26 relative to the lower fibre plant processing element 25 is driven by a number of further lifting cylinders 42 arranged on frame parts 30, 33, wherein increasing the length of lifting cylinders 42 results in an upward rotation of the upper fibre plant processing element 26 relative to the lower fibre plant processing element 25, while reducing the length results in a downward rotation of the upper fibre plant processing element 26 relative to the lower fibre plant processing element 25.

FIG. 4 shows schematically that the relatively long fibre plants (h), such as hemp, kenaf or similar fibre plants, have an overall length Iₜₒₜ (characteristically between 1.4 and 4.0 metres, 2.4 metres on average). The lower part (h1) of each of the fibre plants (h) has a length lₒ (for instance 110 cm to 120 cm), while the upper part (h2) has a length I_{b} (for instance 120 to 130 cm). In the shown embodiment both lengths Iₒ and I_{b} are roughly the same, although in practice these lengths may of course differ. What is important is only that the fibre plants (h) are cut into at least two parts (h1, h2) and then processed further by processing machine 1. Said lower fibre plant processing element 25 is for this purpose made suitable for picking and processing the lower fibre plant parts (h1), while the upper fibre plant processing element 26 is intended for picking the upper fibre plant parts (h2).

The upper fibre plant processing element 26 comprises a transport installation 46 for gripping fibre plants and transporting them to vehicle 2, while the lower fibre plant processing element 25 comprises a (preferably wholly or almost wholly identical) transport installation 45 whereby fibre plants can likewise be gripped and transported to vehicle 2. When vehicle 2 travels in a forward direction (P_{A,V}), the upper fibre plant processing element 26 will reach the fibre plants first. After a short time interval the lower fibre plant processing element 25 will also reach these same fibre plants. In other words, the engaging position at which the upper fibre plant processing element 26 engages a determined fibre plant at a determined point in time is shifted relative to the engaging position at which the lower fibre plant processing element 25 engages a (different) fibre plant at the same point in time. This has the result that the upper fibre plant processing element 26 first engages the upper part (h2) of the fibre plants and cuts them loose from the lower part (h1) with one or more cutting units 55 provided on the front side of the upper fibre plant processing element 26, while it is after this, so only when upper part h2 has been cut loose and is already being carried away, that the lower fibre plant processing element 25 will engage on the lower part (h1) of the same fibre plant.

The lower fibre plant processing element 25 is configured to engage the lower part (h1) of the fibre plant. As a result of the forward movement of vehicle 2 and/or as a result of displacement by means of the transport installation 45 to be described further below the fibre plants are gripped. During the process of gripping the lower hemp parts are received and temporarily moved toward each other so that they are pressed increasingly against each other. While the lower hemp parts are being received and pressed together and/or immediately after they have been pressed wholly together and therefore gripped, the lower hemp parts are cut loose from the roots in the ground, for instance by means of a cutting unit 100 provided on the front side of the lower fibre plant processing element 25.

As shown in FIG. 4, the gripped upper part (h2) of a fibre plant (h) which has been cut loose with cutting unit 55 is picked up by the upper fibre plant processing element 26. This upper part (h2) of the fibre plant comprises a top, flower or seed portion (h5) and a remaining upper portion (h3). As will be elucidated below, in determined embodiments the top portion (h5) of the upper part (h2) of the fibre plant (h) will be removed using a cutting unit. The top portion (h5) is here discharged via discharge means comprising a discharge pipe 28 with an inlet opening close to the cutting unit, a centrifugal fan 20 connected to the discharge pipe and an outlet opening to a receptacle 16 arranged via a frame 17 on the rear side of vehicle 2. As shown in FIG. 4, this receptacle 16 is releasably mounted via rapid couplings 18 on a frame part of frame 6 and will essentially only be used when the intention is to remove the top portions (h5) from a fibre plant. In other words, when the top portion is not cut off, receptacle 16 can optionally be dispensed with.

The lower part (h1) of a fibre plant (h) is similarly composed of a root portion h6 where the roots of the fibre plant are located and a remaining lower part h4. Lower remaining parts h4 of the lower part h1 of each of the fibre plants are separated from the root portion h6 by means of the above stated cutting unit 100 so that the transport installation 45 can transport these lower remaining parts h4 further.

An example of such a cutting unit 100 (wherein it is noted that cutting unit 55 can be constructed in exactly the same way) is shown in FIG. 5A and, in more detail, in FIG. 5B. In determined embodiments cutting unit 55, 100 extends over essentially the whole width of the mutually adjacent passages of processing unit 3 and comprises a number of blades 178 reciprocally movable in lateral direction. In other embodiments there are two or more cutting units positioned mutually adjacently. The reciprocal movement of the blades 178 of cutting unit 55, 100 is driven by a drive motor 179 provided on the side of the support frame. Cutting unit 55, 100 is positioned such (i.e. horizontally in the position of FIG. 5A) that when vehicle 2 travels over the ground, the fibre plants can be cut at a determined (adjustable) height.

FIG. 5A shows a perspective side view of an embodiment of the processing unit 3 with a lower fibre plant processing element 25 and an upper fibre plant processing element 26, while FIG. 6 shows a top view of the lower fibre plant processing element 25. Both figures show the transport installations 45, 46 whereby the fibre plants are gripped and transported to vehicle 2.

The construction and method with which the fibre plants are brought together and pressed against each other so that they are gripped gradually while the vehicle moves forward over the ground will be described below. Since said construction and method are essentially the same for the transport installations 45, 46 of the upper and lower fibre plant processing element 25, 26, merely the description of the construction and operation of one of the transport installations, here particularly of the lower transport installation 45, will suffice here.

Processing unit 3 comprises a support frame 102 comprising frame parts 30 on the lower side of processing unit 3 and frame parts 33 on the upper side of the processing unit. Arranged on the frame parts 30 of support frame 102 is the transport installation 45 for receiving and transporting the fibre plants to vehicle 2. The transport installation 45 comprises a number of mutually adjacently arranged endless belt conveyors 104-109 (FIG. 6) for receiving, gripping and transporting the fibre plants in the same number of streams. In determined embodiments the endless belt conveyors are also configured to rotate/tilt the fibre plants, during transport of these fibre plants, from the substantially upright position the fibre plants are in when they are picked to a substantially lying position before the fibre plants are provided to the conveyors 11, 12 of vehicle 2 itself. The number of endless belt conveyors may vary. In the embodiment shown in FIG. 6 six conveyors are shown for gripping and transporting the fibre plants in six streams, although in other embodiments this number can be greater or smaller as desired.

The streams of fibre plants are supplied between guide elements 40 provided on the front side of both the lower fibre plant processing element 25 and the upper fibre plant processing element 26. Their object is to make it possible to be able, when the vehicle and the processing unit 3 mounted thereon are advanced, to push the fibre plants (h) aside and guide them into a number of, in FIGS. 5A and 6 six per hemp picking unit (although this can also be a greater or smaller number in other embodiments), passages (for instance passages 164-169 of the lower picking element 25). In the shown embodiment there are therefore six passages in the upper fibre plant processing element 26 and six passages in the lower fibre plant processing element 25, wherein all passages are configured to receive and grip the fibre plants. The total of twelve passages (i.e. six per fibre plant processing element) are further formed between the above stated belt conveyors 104-109.

More specifically, said guide elements 40 can for instance be formed from steel wire which forms a pointed protruding part wherein a passage for fibre plants is then provided between two adjacent guide elements 40. When vehicle 2 and the processing unit 3 mounted thereon are advanced over the ground surface, the guide elements push aside the fibre plants (h) and guide them to a respective corresponding receiving area 150 (shown hatched in FIG. 6), where the fibre plants are received and gripped.

Belt conveyor 104 (and this applies in principle also to the other belt conveyors 105-109, wherein a description of the remaining belt conveyors has been omitted for the sake of clarity) comprises a number of main guide rollers (for instance main guide rollers 110-117 of the endless belt conveyor 104 of FIG. 6) mounted on the support frame. An endless main conveyor belt 124 is guided along (inter alia) these main guide rollers 110-117. This endless main conveyor belt 124 is driven by a drive, for instance in the form of a single drive motor 119 (per main conveyor belt) (FIG. 4), for instance a drive motor in the form of a hydraulic or electric actuator, whereby the main guide roller 113, and thereby the main conveyor belt 124 guided therealong, can be rotated. In other embodiments the single drive motor drives a pair of (i.e. two) main conveyor belts (in synchronous manner). Belt conveyor 104 further comprises a number of auxiliary guide rollers 131 mounted on a frame part 30 of support frame 102 (wherein in the shown embodiment the guide roller 110 is simultaneously an auxiliary guide roller and a main guide roller and wherein in other embodiments, which are not shown, other main and auxiliary guide rollers correspond with each other or none of the main guide rollers correspond with an auxiliary guide roller). An endless auxiliary conveyor belt 125 is guided along these auxiliary guide rollers 130-133 (and preferably also along at least one of the main guide rollers 110-117, as in the shown embodiment). This auxiliary conveyor belt 125 is in principle not driven directly (in other words, the auxiliary conveyor belt does not have its own drive for driving thereof) and can essentially be a passive conveyor belt co-rotating with the main conveyor belt 124.

In use, when fibre plants (fibre plants h, shown in FIG. 6 with black dots in as far as the fibre plants are in upright position and shown with broken lines as soon as the fibre plants have been rotated to the lying position) have found their way into the receiving area 150 of one of the passages 164-169 between a main conveyor belt 124 and auxiliary conveyor belt 125 of transport installation 45 due to the forward movement of the vehicle, they are pulled into the conveyor. In the figure the translation directions of the conveyor belts and the rotation directions of the rollers are shown with respective arrows.

Along the first section the fibre plants (h) which have found their way into a passage (for instance passage 164) are as it were enclosed between the first main conveyor belt 124 and the co-rotating auxiliary conveyor belt 125. The fibre plants which have found their way into the adjacent passage, for instance passage 165, are as it were enclosed between the first main conveyor belt 124′ and the co-rotating auxiliary conveyor belt 125′. Further downstream, the two streams of the fibre plants coming from two adjacent passages 164, 165 converge and the two streams continue as one stream between the two main conveyor belts 124, 124¹ lying against each other. This process of combining two streams also takes place at the remaining pairs of passages, such as passages 166, 167 and passages 168, 169, after which the streams from all passages (i.e. all passages per picking element 25, 26) are combined into one single stream and are held and transported between main conveyor belts 124 and 124³. The fibre plants of this single, combined stream of fibre plants are then rotated from the upright position (indicated with dots) to a lying position (indicated with broken lines, see FIG. 6. The rotated fibre plants of the lower picking element 25 are subsequently provided to the above stated conveyor 11 of vehicle 2 (FIG. 2) and then transported to the rear of the vehicle and placed down onto the ground in a first row (swathe) 15b. The rotated fibre plants of the upper picking element 26 are similarly supplied to conveyor 12 and placed down onto the ground in a second row (swathe) 15a.

The inlet side of transport installation 45 will be described in more detail in the following.

As stated above, main conveyor belt 124 and auxiliary conveyor belt 125 define a receiving area 150 for receiving, pressing together and finally gripping the fibre plants between the main and auxiliary conveyor belt, and a mutual contact area 151 in which the main conveyor belt 124 and auxiliary conveyor belt 125 are in direct contact with each other in that they lie against each other locally. Main conveyor belt 124 has a further contact area with an adjacent main conveyor belt 24′ (see FIG. 6) so that the fibre plants can also be held and displaced further further along. At the position of receiving area 150 the main and auxiliary conveyor belts 124, 125 are further positioned relative to each other such that a mutual distance (a) (FIG. 6) in receiving direction (Pₒ) (i.e. while vehicle 2 advances over the ground surface) decreases gradually and transposes into the mutual contact area 151. This means that when vehicle 2 and the processing unit 3 mounted thereon advance, the fibre plants entering receiving area 150 are moved toward each other gradually and are already being carried along to some extent by the conveyor belts. Once they arrive at the mutual contact area 151, the fibre plants are fully gripped between the relevant main conveyor belt and auxiliary conveyor belt.

Owing to the arrangement of the conveyor belts so that a receiving area 150 and a contact area 151 are formed and by forming the receiving area between two conveyor belts 9 (and therefore not between a conveyor belt and a pulley/roller), the fibre plants are gripped and transported to the vehicle more gradually than in other arrangements where the fibre plants are gripped between two rollers or pulleys (which may or may not have one or more conveyor belts therebetween). The length (l) of the gripping area in receiving direction (Pₒ) and the angle (α) at which the main conveyor belt and auxiliary conveyor belt extending obliquely relative to each other and/or obliquely relative to the direction of travel, this in combination with the speed of travel and transport speed of the conveyor belts, affects the manner (gradualness) in which the fibre plants are gripped and transported to the vehicle.

The length (l) of receiving area 150 can for instance be selected to be longer than the largest diameter of each of the main guide rollers and auxiliary guide rollers, in practical applications at least 20 cm (l≥20 cm) or at least 50 cm (l≥50 cm). When the length is at least 20 cm (and preferably longer than 50 cm, or still more preferably longer than 80 cm, for instance between 1200 cm and 1400 cm), this will be found to result at usual driving speeds (between 5 m/s and 18 m/s) and usual conveyor speeds (between 8 m/s and 25 m/s) of the main and auxiliary belts, at an angle (α) of preferably between 5 and 45 degrees, in a good and reliable processing of fibre plants by processing unit 3.

In determined embodiments, such as in the embodiment of FIGS. 6 and 7, receiving area 150 comprises a first receiving area part 155 (shown with a first hatching) and a second receiving area part 156 (shown with a second, different hatching). The mutual angle (α1) in the first receiving area part is here greater than the mutual angle (α2) in the second receiving area part 155. The fibre plants will hereby be brought together with a narrowing with a more than linear progression and be gripped.

Provided in the embodiment shown in FIGS. 5A and 6, besides the main guide roller 116 and auxiliary guide roller 132 which define the start of receiving area 150, is a number of additional main guide rollers 117 and/or auxiliary guide rollers 131 which are positioned adjacently of receiving area 150 and at offset positions along respectively the main conveyor belt 124 and the auxiliary conveyor belt 125. These additional rollers 117, 131 provide for a desired tension in respectively the main conveyor belt 124 and the auxiliary conveyor belt 125 and thereby for a suitable pressing force of the belts (i.e. the force with which main conveyor belt 124 and auxiliary conveyor belt 125 are pressed against each other in the contact area in transverse direction perpendicularly of the direction of the relevant belt and/or the force with which main conveyor belt 124 and auxiliary conveyor belt 125 tend to move toward each other in transverse direction (without the main conveyor belt 124 and auxiliary conveyor belt 125 making contact with each other in the receiving area)) in order to thus press against the fibre plants located between the belts 124, 125. Arranging the rollers at offset positions enables the fibre plants also to be processed well when relatively thick fibre plants (i.e. with thick stems) or relatively thick bundles of pressed-together fibre plants are picked, without (at least a part of) the rollers of the main conveyor belt and auxiliary conveyor belt having to be mounted flexibly on the frame. This is because, when the rollers lie against each other (as in the prior art), at least one of the rollers must be able to yield when (a bundle of) fibre plants of relatively great thickness must pass temporarily, while in the embodiments as described herein it is conversely the conveyor belt (i.e. the main conveyor belt or the auxiliary conveyor belt) that provides the option of yielding. Special technical measures, such as a balancing element (also referred to as a balance wheel), can for instance be dispensed with.

In other embodiments (not shown) at least the above stated additional main guide roller 116 and auxiliary guide roller 132 are dispensed with. In still further embodiments the processing unit 3 comprises a tensioning element 170 on which one or more of the main guide rollers and auxiliary guide rollers are arranged, wherein the tensioning element is configured to be arranged on the pivotable support frame at adjustable positions. In the embodiment shown in FIG. 6 the tensioning element 170 is freely slidable in slot 171 in frame part 30 and can be fixed at a desired longitudinal position. More generally, the tension inside main conveyor belt 124 and auxiliary conveyor belt 125 can be increased and reduced as desired by displacing tensioning element 170 and then arranging it on the pivotable support frame at a suitable position. This is possible both in embodiments with and in embodiments without said additional main guide rollers 116 and auxiliary guide rollers 132.

Because there is no direct contact between the running surface of the main and auxiliary conveyor belts on one hand and the fibre plants on the other in embodiments according to the present description, the (running surfaces of the) main guide rollers and auxiliary guide rollers need not be made of relatively soft material in order to protect the fibre plants. This makes it possible to manufacture the (running surfaces of the) main guide rollers and auxiliary guide rollers from steel, making them less susceptible to wear than the rollers consisting of relatively soft material (plastic, rubber or the like).

In the shown embodiments the main conveyor belts and auxiliary conveyor belts are given substantially the same height, characteristically between 10 cm and 20 cm. In other embodiments the height of the main conveyor belt is however greater than that of the auxiliary conveyor belt, for instance at least twice as high. This has the advantage that replacing can be realized more easily and consequently more quickly. This further has determined advantages in production. The main and auxiliary conveyor belts are preferably made of flexible material, for instance of rubber or a material containing rubber and/or PU material, which on one hand has the flexibility and/or suppleness to be guided along the different guide rollers and on the other is sufficiently inflexible to hold the fibre plants firmly therebetween and to prevent that they are able to fall out of the conveyor during the transport.

Once the fibre plants have arrived in the contact area and are being held between the main conveyor belts and auxiliary conveyor belts, the fibre plants can be cut at a desired position, for instance just above their roots (wherein the roots remain at least largely or wholly in the ground), for instance by a cutting unit 100 mounted on the pivotable support frame. The cutting unit 100 is configured to cut the fibre plants when they are located in the receiving area between the main conveyor belt and auxiliary conveyor belt, when they are located in the contact area between the main conveyor belt and the auxiliary conveyor belt, or both when they are located in the receiving area and when they are located in the contact area.

It is important not to grip the fibre plant too firmly at the position where the fibre plants are cut (this preferably being in the contact area 150). This is because it has been found that when a fibre plant is cut, there must still be some allowance in the position of the fibre plant as a result of the inclination of the processing unit (i.e. the picking unit) relative to the ground surface and/or due to the position of the mowing unit (for instance the mowing bar). The fibre plant must preferably still be able to slide between the conveyor belts to some extent.

In determined embodiments of the invention it is further possible to adjust this height position where the fibre plants are cut (either beforehand or during the processing (and travelling with the vehicle) of the fibre plants). Provided in determined embodiments are means such as a number of skis and/or wheels (not shown in the figures) which are arranged on support frame 102 and follow the ground surface, whereby the position of the support frame and thereby the height thereof automatically follows the height variations in the ground surface during travel. One or more actuators whereby the height position of pivotable support frame 102 and/or of components thereof, such as the cutting unit 55 and/or cutting unit 100, can be varied may also be provided. These actuators can then for instance be controlled by a controller which is connected to a height sensor which is able to determine the height of the ground and/or fibre plant just before the cutting moment. These options of varying in the height can be utilized in order to always cut off the fibre plants at a fixed height, irrespective of the height variation in the ground surface, but can also be utilized to adjust this fixed height. Sometimes, the fibre plants must for instance be cut off just above the roots, in other cases some distance above the roots.

In the shown embodiments of the processing machine fibre plants with thicker stems (and fibre plants with a greater variety in stem thickness relative to each other) can be harvested owing to the gradual infeed. This further also has the practical effect that the processing machine can be utilized more often and longer in the season, also if (a part of) the fibre plants has or have already become relatively (too) large and/or ripe.

The present invention is not limited to the embodiments described herein. The rights sought are defined by the following claims, within the scope of which numerous modifications can be envisaged.

1. A processing machine for processing fiber plants, the processing machine comprising:
a self-propelling or drawn vehicle comprising a vehicle chassis with a plurality of wheels arranged thereon;
a processing system configured to pick the fiber plants or take the fiber plants up from a ground surface, the processing system comprising:
a support frame mounted or mountable on the vehicle chassis,
a transport installation mounted on the support frame and configured to receive and transport the fiber plants to the vehicle, the transport installation comprising
a plurality of main guide rollers mounted on the support frame,
at least one endless main conveyor belt guided along the main guide rollers,
a drive configured to drive the at least one endless main conveyor belt,
a plurality of auxiliary guide rollers mounted on the support frame,
at least one endless auxiliary conveyor belt guided along the auxiliary guide rollers the at least one endless auxiliary conveyor belt being configured to be driven by displacement of the at least one driven endless main conveyor belt,
wherein the at least one endless main conveyor belt and the at least one endless auxiliary conveyor belt define at least one respective receiving area configured to receive and then grip the fiber plants to pick between the at least one endless main conveyor belt and the at least one endless auxiliary conveyor belt and at least one mutual contact area, wherein the at least one endless main conveyor belt and the at least one endless auxiliary conveyor belt being in contact with each other,
wherein the at least one endless main and auxiliary conveyor belts are disposed at a position of the receiving area in order to define a respective mutual distance which decreases gradually in a receiving direction and transposes into the at least one mutual contact area.

2. The processing machine according to claim 1, further comprising guide elements mounted on a front outer end of the frame, as viewed in a direction of travel of the processing machine, the guide elements being configured to guide and push aside the fiber plants to pick into one or more passages, the receiving area being disposed between the guide elements and between the at least one endless main and auxiliary conveyor belts, each of the guide elements forming a pointed protruding part, one of the one or more passages for the fiber plants being formed between each two adjacent pointed protruding parts.

3. The processing machine according to claim 1, wherein the at least one endless main conveyor belt is configured to drive the at least one endless auxiliary conveyor belt in the mutual contact area.

4. The processing machine according to claim 1, wherein the at least one endless main conveyor belt comprises a first endless main conveyor belt guided along main guide rollers, and a second endless main conveyor belt guided along the main guide rollers,
wherein the at least one endless auxiliary conveyor belt comprises a first endless auxiliary conveyor belt guided along auxiliary guide rollers and at least a first one of the main guide rollers, and a second endless auxiliary conveyor belt guided along the auxiliary guide rollers and at least a second one of the main guide rollers,
wherein the first endless main conveyor belt and first endless auxiliary conveyor belt define a first receiving area to receive and grip first ones of the fiber plants between the first endless main conveyor belt and the first endless auxiliary conveyor belt,
wherein the second endless main conveyor belt and second endless auxiliary conveyor belt define a second receiving area of the at least one receiving area to receive and grip second ones of the fiber plants between the second endless main conveyor belt and the second endless auxiliary conveyor belt,
wherein the first endless main and auxiliary conveyor belts are disposed in the first receiving area in order to define the respective first mutual distance which decreases gradually in the receiving direction and transposes into a first mutual contact area of the at least one mutual contact area, and the second endless main and auxiliary conveyor belts are disposed in the second receiving area in order to define the respective second mutual distance which decreases gradually in the receiving direction and transposes into a second mutual contact area of the at least one mutual contact area;
wherein the processing machine further comprises:
a combining area configured to combine the first and second fiber plants supplied via the first and second mutual contact areas, and
an additional contact area between the first endless main conveyor belt and the second endless main conveyor belt to transport the combined first and second fiber plants further between the first and second endless main conveyor belts.

5. The processing machine according to claim 4, wherein the processing machine is configured to rotate the fiber plants in the additional contact area.

6. The processing machine according to claim 1, wherein the respective receiving area between the at least one endless main conveyor belt and the at least one endless auxiliary conveyor belt is longer in the receiving direction than the greatest diameter of each of the main guide rollers and the auxiliary guide rollers.

7. The processing machine according to claim 1, wherein the respective receiving area between the respective endless main conveyor belt and the respective endless auxiliary conveyor belt is longer in the receiving direction than 20 cm.

8. The processing machine according to claim 1, wherein the at least one respective receiving area narrows gradually in the receiving direction.

9. The processing machine according to claim 1, wherein, in the respective receiving area, the at least one endless main conveyor belt and the at least one endless auxiliary conveyor belt extend obliquely relative to each other in the receiving direction.

10. The processing machine according to claim 1, wherein, in the respective receiving area, the at least one endless main conveyor belt and the at least one endless auxiliary conveyor belt extend in the receiving direction at a mutual angle between the at least one endless main conveyor belt and the at least one endless auxiliary conveyor belt of between 5 and 45 degrees.

11. The processing machine according to claim 8, wherein the respective receiving area has a first receiving area part and a second receiving area part,
wherein the mutual angle is greater in the first receiving area part than in the second receiving area part.

12. The processing machine according to claim 1, further comprising one or more additional main guide rollers and additional auxiliary guide rollers which are positioned at offset positions respectively along the at least one endless main conveyor belt and the at least one endless auxiliary conveyor belt.

13. The processing machine according to claim 1, further comprising a tensioning element on which one or more of the main guide rollers and the auxiliary guide rollers are disposed, the tensioning element being configured to be disposed on the support frame at adjustable positions.

14. The processing machine according to claim 1, wherein one or more of the auxiliary guide rollers and the main guide rollers are made of steel and have at least a steel running surface.

15. The processing machine according to claim 1, wherein the at least one endless main conveyor belt has a height which is greater than a height of the at least one endless auxiliary conveyor belt.

16. The processing machine according to claim 1, wherein at the free outer end of the receiving area the mutual distance between the main conveyor belt and auxiliary conveyor belt in a direction transversely to the receiving direction amounts to at least 20 cm.

17. The processing machine according to claim 1, further comprising a cutting system mounted on the support frame, the cutting system being configured to cut through the fiber plants when the fiber plants are situated in the respective receiving area between the at least one endless main conveyor belt and the at least one endless auxiliary conveyor belt.

18. The processing machine according to claim 1, wherein the vehicle is self-propelling and has a drive motor configured to drive at least two of the wheels, and/or
wherein the support frame is is pivotally mounted or mountable on the vehicle chassis.

19. The processing machine according to claim 1, wherein the support frame is pivotable in one or more of a lateral direction and an upward direction.

20. The processing machine according to claim 1, wherein the at least one endless auxiliary conveyor belt is guided along at least one of the main guide rollers.
